(19) United States
(12) Patent Application Publication
(10) Pub. No.: US 2015/0337404 A1
(43) Pub. Date: Nov. 26, 2015

(54) METHOD AND DEVICE FOR PREDICTING, CONTROLLING AND/OR REGULATING STEELWORKS PROCESSES

(71) Applicant: SMS SIEMAG AG, Düsseldorf (DE)

(72) Inventors: Norbert Uebber, Langenfeld (DE); Jochen Schlueter, Dortmund (DE); Hans-Juergen Odenthal, Mettmann (DE); Katharina Morik, Koeln (DE); Hendrik Blom, Dortmund (DE)

(73) Assignee: SMS Siemag AG, Duesseldorf (DE)

(21) Appl. No.: 14/653,316

(22) PCT Filed: Dec. 9, 2013
(86) PCT No.: PCT/EP2013/075907

§ 371 Date: Jun. 18, 2015

(30) Foreign Application Priority Data
Dec. 21, 2012 (DE) 10 2012 224 184.1

(51) Int. Cl. C21C 5/30; G05B 19/418

(52) U.S. Cl. CPC C21C 5/30; G05B 19/41885; G05B 2219/32194

(57) ABSTRACT

The present invention relates to a method for predicting, controlling and/or regulating steelworks processes, comprising the steps of monitoring at least two input variables related to a target variable, determining the relationship between the at least two input variables and at least one target variable by means of regression analysis or classification methods, and using the determined target variable for predicting, controlling and/or regulating the steelworks process.

### TECHNICAL FIELD

The present invention relates to a method for predicting, controlling and/or regulating steelworks processes, such as converter and arc furnace processes, for example, which are provided for producing molten steels from feedstock and raw materials.

### PRIOR ART

During the conversion of feedstock and raw materials during the production of steel in steelworks, such as converter and arc furnace processes, for example, molten steels are produced, which must satisfy specific requirements.

The main conversion process with converter processes is to reduce the initial high carbon content to low values. This is typically done by means of oxygen that is blown-in via lances or nozzles on the metallurgical vessel. Apart from this essential purpose to reduce the carbon content within the metallic melt, there are additional substantial target variables, namely attaining a specific phosphorus or manganese content, as well as specific melting temperatures when tapping, wherein an optimized content of iron oxide (FeO) is desirable preferably at the same time in order to produce metallurgical processes without incinerating lots of the feedstock or to keep chrome losses low during the decarbonization.

Terminating the blowing process in the converter process too early or too late has adverse consequences, furthermore. Thus, if the blowing process is terminated too early, this will require an afterblow and the associated loss of time and production. Terminating the blowing process too late results in excessive iron smelting loss, downtimes, coolant expenditure and increased refractory wear and therefore inefficient production.

Up to this time, the blowing end-point or the time of tapping in the converter process was determined by means of static or dynamic model calculations. In this context, the respective processing models essentially have the purpose to predict operating parameters that cannot be measured directly, such as the temperature of the metallic melt as well as the chemical composition of the melt. In this context, the known dynamic model calculations are based on mass and energy balances that calculate the current status of the metallic melt in the converter. With dynamic models, the progress of decarbonization is furthermore calculated by means of the measured waste gas behavior and from that the quantity of oxygen still to be converted is calculated as well as the blowing end-point.

It is furthermore known to determine the blowing end-point and the time of tapping by means of a so-called sublance. For this purpose, towards the end of the respective converter process, a probe is introduced into the metallic melt to directly determine temperature and composition of the melt, for example with respect to the carbon content, the phosphorus content, the manganese content, etc. Because of the increased reliability of the data situation accomplished in this manner, significantly simpler models can be used and the prediction accuracy is improved. In addition to the so-called sublance, also so-called “quick bombs,” i.e. non-lance associated immersion probes can be used, which are thrown into the melt through the converter mouth on a rope with measuring lines, and which still supply measuring data to the outside for a certain time.

A further known method to determine the end-point and the time of tapping are performed by means of a waste gas measurement, wherein here the status of the melt is specifically deduced by means of the percentage of carbon monoxide or of carbon dioxide, which varies as the progress of decarbonization proceeds. Furthermore, the decreasing luminosity of the converter flame at the end of the process is monitored using so-called light meters, and the blowing end-point is deduced from that. This involves values that are determined empirically, wherein if the value of a specific CO, CO₂ or radiation value drops below a certain level, conclusions are drawn with respect to a specific carbon or phosphorus tails assay.

The disadvantage of using sublances is that these are expensive to buy and maintain, and that the determination of the end-point as a result of using the sublance can also not be clarified completely, since after determination of the temperature as well as the chemical composition of the melt, the specified values for the target variables for the remaining oxygen quantity or blow time must still be estimated. Moreover, the sublance sampling process must be interrupted.

The determination of the end-point based on monitoring the waste gas contents, the converter flame luminosity and the vibration characteristics of the lance, is widely spread. However, only monocausal relationships are utilized here, i.e. for example the determination of the “carbon content” target variable in the melt as a function of the CO or CO₂ content target variables in the waste gas or the “phosphorus content” in the metal melt, depending on the vibration intensity of the lance. In this context, rigid limit values are typically used here, which do not account for potential drifting of the measuring arrangement or changes of the system characteristics.

Furthermore, there is no definite textbook correlation between the selected unique input quantity and the selected target variables. Correspondingly, this justifies neither the fact that the final conditions of the converter processes is a result of many influencing variables, i.e. depending on the lance modes of operation, the formation of reactive slags, etc., for example, nor the fact that the measurement of the respective input quantities are subject to variations, which can result in misinterpretations. For example, the sampling pipe lines of the waste gas analysis systems can clog over time, or by changes in the waste gas system, for example by different setting ring positions or pressure controls in the waste gas system, undefined quantities of entrained air can be drawn-in, which can falsify the correlation between the progress in decarbonization and the waste gas content measured. Furthermore there is a significant time delay between taking the sample and analyzing it, since the gases must still be cooled and purified.

In the paper by Ling-Fei Xu, Quiezau et al “Signal spectrum endpoint predict of BOF with SVM”, World Academie of Science, Engineering and Technology 62, 2010, pp 434 et seqq, it is furthermore described how to determine a blowing end-point in a BOF [Basic Oxygen Furnace] converter by means of a Support Vector Machine (SVM), which is an algorithm for numerical prediction of values. In this example, the determination is carried out by means of converter flame luminosity.

### SUMMARY OF THE INVENTION

Based upon the above-mentioned prior art, the purpose of the present invention is to indicate a further improved method for prediction, control and/or regulating of converter processes.

This object is solved by a method having the features of claim 1. Advantageous developments result from the dependent claims.

Correspondingly, the method for prediction, control and/or regulation of converter processes includes the following steps: Monitoring at least two input variables related to a target variable, determining the relationship between the at least two input variables and at least one target variable by means of regression analysis or classification methods, and using the determined target variable for predicting, controlling and/or regulating the steelworks process.

As a consequence of that the target variable is determined from entities to input variables by means of regression analysis or classification methods, or that the correlation between the input variables and the target variables is determined by means of regression analysis or classification methods, the respective metallurgical processes can be predicted more accurately and the value of the target variables, which are specified for the respective product, such as the tapping temperature and the chemical composition, can be attained more accurately.

For this purpose, multiple input variables can also be set correlated to multiple target variables, so that particularly the product characteristics of the melt in the converter process, such as the tapping temperature, the tails assay of carbon, the tails assay of phosphorus, the iron content of slag, etc. at the blowing end-point can be predicted simultaneously.

The fact that in each case two input variables are correlated with one target variable shows that a change of the two input variables suggests a specific characteristic or change of the target variable in each case. For example, by mean of the waste gas composition and the radiant power of the converter flame, the tails assay of carbon in the melt can be determined. By an acoustic measurement at the converter in combination with the lance vibration it is possible to deduce the phosphorus content of the tails assay or the iron oxide content in the slag. The tapping temperature can in turn be determined by means of the waste gas temperature and by the power losses measured, for example.

The method is preferably performed in real time to permit reliable control of the respective steelworks processes on schedule.

Preferably, the Support Vector Machines (SVM) method is used for determining the target variable. The SVM method can be used both for classification as well as also for regression.

Since among the aforementioned input variables and the respectively aforementioned target variables this does not involve unambiguous correlations defined by means of textbook knowledge, classic modeling is not feasible here. By means of the SVM, it is however possible that the target variable can be deduced based on the respective input variables identified. For this purpose, it is naturally necessary that the SVM can resort to a database on the basis of which the SVM can perform the required learning process. In this context, the input variables will preferably be preprocessed, which can consist of a combination of static and dynamic input variables, a combination of dynamic input variables and/or an aggregation of dynamic, combined and and/or transformed input variables.

It is furthermore advantageous, if the SVM method is carried out such that after completion of a respective converter process, the tapping temperature as well as the chemical composition of the melt are measured directly, and the measured correlations are provided to the SVM for further improvement of the learning process.

Preferably, in addition to the dynamic input variables, such as lance vibrations, waste gas compositions, waste gas temperature, sound level/s, cooling water temperature, lance guidance etc., also static input variables are used in the SVM algorithm. These static input variables are for example the converter age, the lance age, the quantity and the type of feedstock and admixture materials, etc. In principle, any optional number of input variables in correlation with a specific target variable can be set with the SVM algorithm.

In this case, static input variables are to be understood as input variables, which are measured or collected at discrete times, such as the charge rates or the analyses, or also discrete characteristics and conditions of the resources used, such as the state of wear of the converter and the lance at the outset.

Dynamic input variables are to be understood as such input variables, which are acquired ongoing and essentially continuously during the converter process, such as waste gas temperature, waste gas analysis, acoustic measurements and vibration measurements, etc.

An improvement of the accuracy of the method can be accomplished, for example, in that apart from the respective input variables that were actually measured, also the results of model calculations can be incorporated in the prediction calculations of the SVM method. The SVM requires a database to be as broad as possible, based upon which a correlation between the input variables and the respective target variables can be established. This database can be improved by means of model calculations which can produce known correlations between input variables and target variables.

To compensate for drifting of the measuring devices, it is possible that the most current input variables and measuring data can be weighted more heavily, for example. The measuring data are preferably weighted differently, in order to counteract a continuous variation of the measuring errors of the measuring data, preferably pursuant to heavier weighting of the most current measuring data.

Furthermore it is preferable to establish in addition to the more accurate prediction of the blowing end-point also correlations between the values of the target variables in the melt and the respective input variables, from which the specifications for a targeted influencing of the final properties of the process can be deduced, for example, such as how much heating media or cooling media must be used for attaining specific melting temperatures.

Furthermore it is an advantage, if the most current data during the course of the process are utilized dynamically in order to match a dynamic adaptation of the correlations learned in the SVM in each case, for example the aging of the converter. Furthermore, for example, the waste gas analyses in the BOF process, which can be used as input variable with the SVM method, are affected because of increasing dust deposits within the respective waste gas piping. The continuous adaptation of the learned correlations in the SVM method and the simultaneous utilization of other input variables, such as the light emission of the converter flame, which is also in correlation with the carbon content of the melt, makes it possible to compensate for corresponding translations of individual input variables.

In this case it is advantageous that the SVM method can be operated in high magnitudes, which means that many input variables can thus be allowed for. The SVM method can moreover also be applied for non-linear problems, so that the determination of the respective blowing end-point or the prediction of target variables can also be reliably solved for the essentially non-linear processes in the converter.

For the determination of the tails assay of carbon in the melt, preferably the waste gas composition as well as the radiant power of the converter flame can be used as a dynamic input variable. For the determination of the tails assay of phosphorus and/or the iron oxide content in the slag, the sound at the converter as well as the vibrations of the lance can be used as dynamic input variables. The waste gas temperature as well as the power loss represented in the cooling system can be used as dynamic input variables for determining the tapping temperature.

The proposed method can furthermore also be utilized for other target variables such as the final characteristics of the metallic melt. The tendency of the slag spittings on the BOF process can be determined as a target variable, for example, and by the simultaneous monitoring of the correlated measured variables, such as acoustic measurement, lance vibration, waste gas measurement etc., with dynamic determination of criteria which require countermeasures, can result in reliable and accurate predictions, if the constraints are taken into account accurately, such as in the silicon content of the crude iron, low-grade scrap varieties, etc.

### BRIEF DESCRIPTION OF THE FIGURES

Preferred additional embodiments and aspects of the present invention are explained in greater detail by means of the following description of the FIGURE, as follows:

FIG. 1 is an example of a schematic flow diagram of the present method.

### DETAILED DESCRIPTION OF EMBODIMENTS

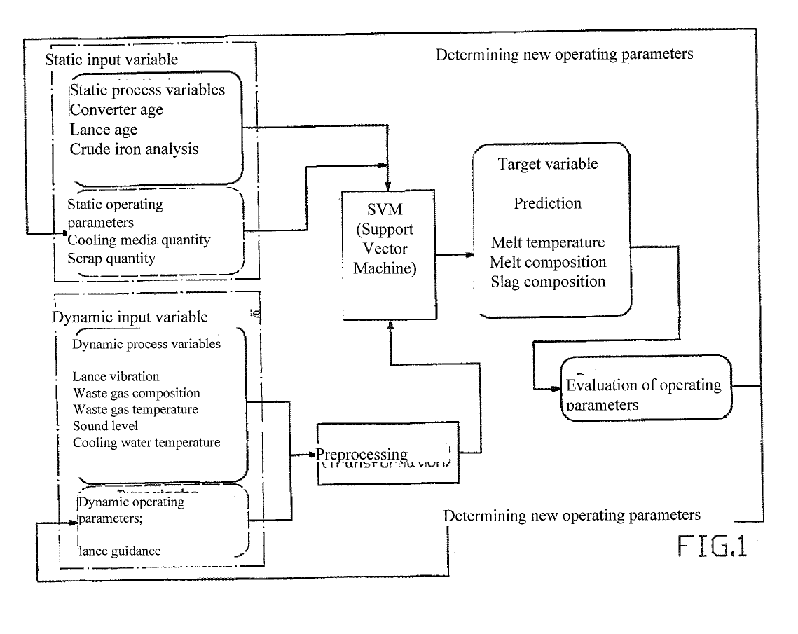

FIG. 1 is a schematic presentation of a method, which uses the SVM algorithm. In this instance, static input variables are provided, such as the converter age, the lance age, an analysis of the crude iron etc. and are provided to the SVM algorithm Furthermore also static input variables are provided in the form of static of static operating parameters, such as the coolant quantity, the quantity of scrap etc., and are provided to the SVM algorithm.

Furthermore also dynamic input variables in the form of dynamic process variables, such as the lances vibrations, the waste gas composition, waste gas temperature, sound level/s, cooling water temperature etc. are provided to the SVM algorithm, preferably following a preprocessing step, particularly a transformation step. Furthermore also dynamic input variables in the form of dynamic process variables, such as the lance guidance etc. are provided to the SVM algorithm, preferably following a preprocessing step, particularly a transformation step.

By means of the SVM, a prediction regarding a target variable can be made, for example regarding the melting temperature, the melt composition and/or the slag composition to be expected. The distance between the given target values of the target variables and the prognosis of the target variables can be understood as an optimizing function. This function can be optimized by means of a multi-criteria optimization method regarding the operating parameters such as an addition of heating or cooling media, the lance guidance and the shutdown criteria. A solution can be selected from the multitude of operating parameters determined that have led to the Pareto optimal solutions, so that a new solution can be selected and new operating parameters can be determined accordingly.

By input variables, the variables are to be understood that were measured or determined during or after the process sequence. Variables that can be measured directly are for example temperatures and compositions of the metallic melt that were measured by means of sublances or “quick bombs.” Indirect variables are variables that suggest a possible target variable, but without any textbook context, such as the sound level in the converter, vibrations of the lance, optical measurements on the converter flame, waste gas measurements, etc.

A target variable is such variable that indicates a characteristic of the product that is to be attained by means of the steelworks process. The target variable can adopt different values for different metallic melts or for different application fields. Target variables are the tipping temperature, for example, as well as the chemical compositions of melt and slag. Frequently, also multiple targets variables are provided which are to be optimized such that a quantity of Pareto optimal solutions is determined, for example for a tapping temperature, the carbon content and the phosphorus content of the metallic melt.

In this case, by operating parameters, those parameters are understood that are used for management, controlling and/or regulating the respective steelworks process. This includes for example the scrap composition, the initial content of the carbon in the crude iron following the filling into the metallurgical vessel, the distribution of the solid feedstock and admixture materials in the converter, the addition of cooling media, the addition of energy, the blowing period during the converter process, the processing time or the time of tapping, etc. Accordingly, the operating parameters involve real values, by means of which the respective metallurgical process or the steel process can be managed or be influenced.

Any individual features, which are represented in the individual embodiments, can be combined and/or replaced to the extent possible, without departing from the scope of the invention.

1. A method for predicting, controlling and/or regulating steelworks processes, comprising the steps:
monitoring of at least two input variables related to one target variable,
determination of the correlation between the entities to input variables and at least one target variable by means of regression analysis or classification method, and
utilization of the determined target variable for predicting, controlling and/or regulating the steelworks process, wherein a SVM (Support Vector Machine) method is used for determining the target variable, and wherein the SVM is provided both input variables as well as also dynamic input variables.

2. The method according to claim 1, wherein the method is carried out in real time.

3. (canceled)

4. The method according to claim 1, wherein multiple input variables and a lesser number of target variables are correlated to one another by means of the SVM method.

5. The method according to claim 1, wherein results from model calculations of the SVM method are provided, preferably for broadening the database.

6. (canceled)

7. The method according to claim 1, wherein preprocessing of the input variables is carried out such that static and/or dynamic input variables are combined, dynamic input variables are transformed, and or dynamic, combined and/or transformed input variables are aggregated.

8. The method according to claim 1, wherein measuring data are weighted differently, in order to counteract a continuous variation of the measuring errors of the measuring data, preferably by heavier weighting of the most current measuring data.

9. The method according to claim 1, wherein for the determination of the tails assay of carbon in the melt, the waste gas composition as well as the radiant power of the converter flame is used as a dynamic input variable.

10. The method according to claim 1, wherein for the determination of the tails assay of phosphorus and/or the iron oxide content in the slag the sound at the converter as well as the vibrations of the lance can be used as dynamic input variables.

11. The method according to claim 1, wherein for the determination of the tapping temperature, the waste gas temperature as well as the power loss represented in the cooling system of the waste gas, can be used as dynamic input variables.

12. The method according to claim 1, wherein operating parameters are determined based upon the target variable determined by means of a SVM method.

13. The converter comprising a device, which is set up for performing a method according to claim 1.
